(19) United States
(12) Patent Application Publication
(10) Pub. No.: US 2008/0164678 A1
(43) Pub. Date: Jul. 10, 2008

(54) AIR RIDE HITCH

(76) Inventor: Gary White, Grygla, MN (US)

Correspondence Address: MERCHANT & GOULD PC, P.O. BOX 2903, MINNEAPOLIS, MN, 55402-0903, US

(21) Appl. No.: 11/969,639

(22) Filed: Jan. 4, 2008

Related U.S. Application Data
(60) Provisional application No. 60/883,544, filed on Jan. 5, 2007.

(51) Int. Cl. B60D 1/00

(52) U.S. Cl. 280/504

(57) ABSTRACT

A hitch assembly used in towing vehicles or other machines includes a first portion configured to be mounted on a towing vehicle and a second portion configured to be attached to a towed vehicle. At least one of the first portion and the second portion is configured to slidably move relative to the other of the first portion and the second portion vertically in both the upward direction and the downward direction.

### CROSS-REFERENCE TO RELATED APPLICATIONS

This application claims the benefit of U.S. Provisional Application No. 60/883,544, filed on Jan. 5, 2007, which application is incorporated herein by reference.

### TECHNICAL FIELD

The principles disclosed herein relate generally to a towing hitch system for connecting a towing vehicle, such as an automobile or truck, to a vehicle to be towed (e.g., a trailer). More particularly, the present disclosure relates to a force or shock absorbing towing hitch.

### BACKGROUND

Conventional trailer hitch devices comprise a ball mount coupled to a towing vehicle. The ball mount carries a towing ball, to which is connected a towing tongue of the towed vehicle. In the course of towing, forces and vibrations created by irregularities in the road surface are transferred between the trailer and the towing vehicle, causing undue wear on the trailer and on the towing hitch and producing jolts which can be felt by occupants of the towing vehicle.

Hitch designs that provide force absorbing capabilities are available in the art. However, current force absorbing hitch designs provide shock absorption only one direction, the downward direction. Current designs do not accommodate for forces in other directions, such as the upward direction.

There is a need in the art for an improved shock absorbing towing hitch design.

### SUMMARY

According to one aspect of the disclosure, the principles disclosed herein relate to a towing hitch that provides shock absorption protection in a plurality of directions, such as both in the downward direction and the upward direction.

In one aspect, the disclosure is directed to a towing hitch assembly that rides on a cushion of air providing continuous shock absorption protection in both the downward and the upward directions.

According to another aspect, the disclosure is directed to a towing vehicle including a hitch assembly configured for towing a towed vehicle, the hitch assembly providing continuous shock absorption protection to the towing vehicle in both the downward and the upward directions.

According to yet another aspect, the hitch assembly includes a first portion configured to be mounted on a towing vehicle and a second portion configured to be attached to a towed vehicle. At least one of the first portion and the second portion is configured to slidably move relative to the other of the first portion and the second portion vertically in both the upward direction and the downward direction.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1A is a front top perspective view of a hitch having features that are examples of inventive aspects in accordance with the principles of the present disclosure;

FIG. 1B is a front bottom perspective view of the hitch of FIG. 1A;

FIG. 2 is an exploded view of the hitch of FIG. 1A;

FIG. 3 is a side view of the hitch of FIG. 1A;

FIG. 4 is a side view of the hitch of FIG. 1A, shown without a side cover;

FIG. 5 is a rear view of the hitch of FIG. 1A;

FIG. 6A is a rear view of the hitch of FIG. 1A, the hitch shown without the rear wall of the rear housing to illustrate the internal components of the hitch;

FIG. 6B is a cross-sectional view taken along line 6B-6B of FIG. 3;

FIG. 6C is a cross-sectional view taken along line 6C-6C of FIG. 3;

FIG. 7 is a side view of the hitch of FIG. 1A, illustrating the hitch absorbing a downward force with the front assembly of the hitch having moved downwardly relative to the rear assembly of the hitch;

FIG. 8 illustrates a front view of the hitch of FIG. 7;

FIG. 9 illustrates a rear view of the hitch of FIG. 7;

FIG. 10 is a side view of the hitch of FIG. 1A, illustrating the hitch absorbing an upward force with the front assembly of the hitch having moved upwardly relative to the rear assembly of the hitch;

FIG. 11 illustrates a front view of the hitch of FIG. 10;

FIG. 12 illustrates a rear view of the hitch of FIG. 10;

FIG. 13 is a perspective view of the front housing of the front assembly of the hitch of FIG. 1A;

FIG. 14 is a front view of the front housing of FIG. 13;

FIG. 15 is a rear view of the front housing of FIG. 13;

FIG. 16 is a side view of the front housing of FIG. 13;

FIG. 17 is a perspective view of the ball mount of the hitch of FIG. 1A;

FIG. 18 is a side view of the ball mount of FIG. 17;

FIG. 19 is a bottom view of the ball mount of FIG. 17;

FIG. 20 illustrates the receiver ball mounted on the ball mount of FIG. 17;

FIG. 21 illustrates the bolt assembly used for mounting the ball mount to the bracket of the front housing of FIG. 13;

FIG. 22 illustrates the ball mount of FIG. 20 mounted on the bracket of the front assembly of the hitch in a first position;

FIG. 23 illustrates the ball mount of FIG. 20 mounted on the bracket of the front assembly of the hitch in a second position;

FIG. 24 illustrates the ball mount of FIG. 20 mounted on the bracket of the front assembly of the hitch in a third position;

FIG. 25 illustrates the ball mount of FIG. 20 mounted on the bracket of the front assembly of the hitch in a fourth position;

FIG. 26 illustrates the ball mount of FIG. 20 mounted on the bracket of the front assembly of the hitch in a fifth position;

FIG. 27 is a perspective view of the rear assembly of the hitch of FIG. 1A;

FIG. 28 is a side view of the rear assembly of FIG. 27;

FIG. 29 is a rear view of the rear assembly of FIG. 27;

FIG. 30 is a right perspective view of the internal assembly of the hitch of FIG. 1A;

FIG. 31A is a front view of the internal assembly of FIG. 30;

FIG. 31B is a rear view of the internal assembly of FIG. 30;

FIG. 32 is a left side view of the internal assembly of FIG. 30;

FIG. 33 is a right side view of the internal assembly of FIG. 30;

FIG. 34 is a cross-sectional view taken along line 34-34 of FIG. 5;

FIG. 35 is a cross-sectional view taken along line 35-35 of FIG. 9;

FIG. 36 is a cross-sectional view taken along line 36-36 of FIG. 12;

FIG. 37 illustrates the shock absorber of the internal assembly of FIG. 30; and

FIG. 38 illustrates a diagram showing a towing vehicle that includes the hitch of FIGS. 1-12 for towing a towed vehicle, the diagram illustrating the positioning of the hitch relative to the towing vehicle and the towed vehicle.

### DETAILED DESCRIPTION

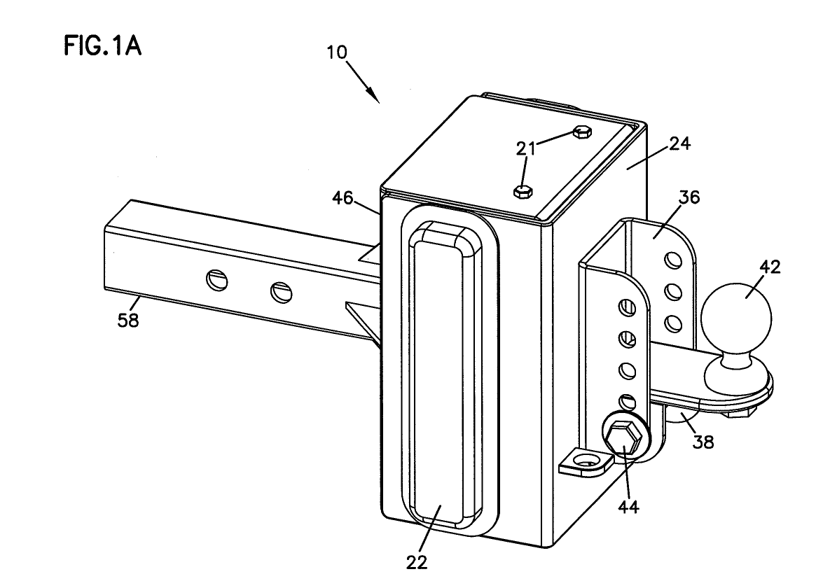

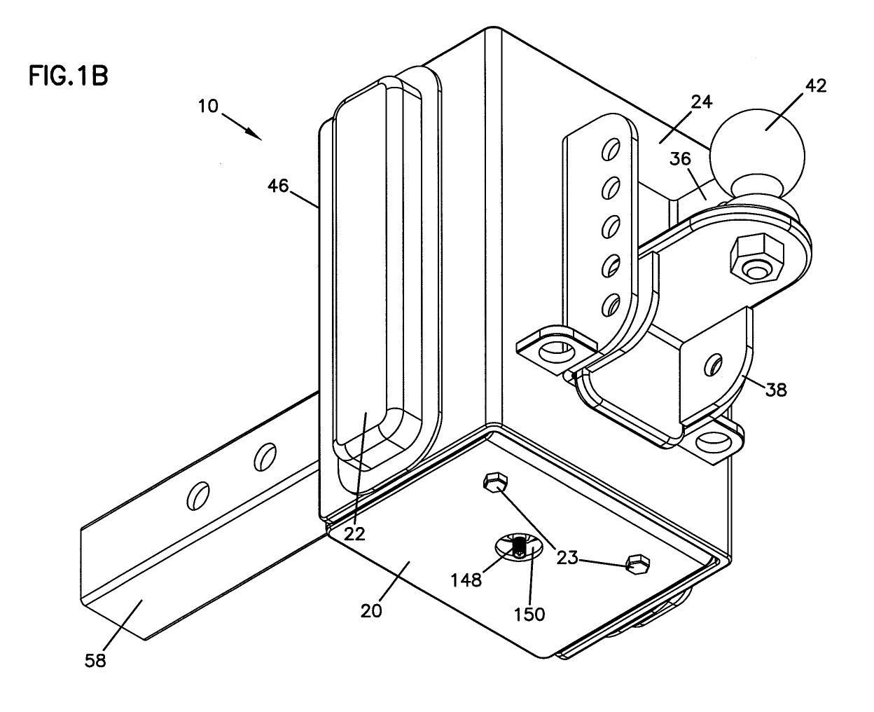

An embodiment of a hitch having features that are examples of inventive aspects in accordance with the principles of the present disclosure is shown in FIGS. 1-12, designated generally at 10.

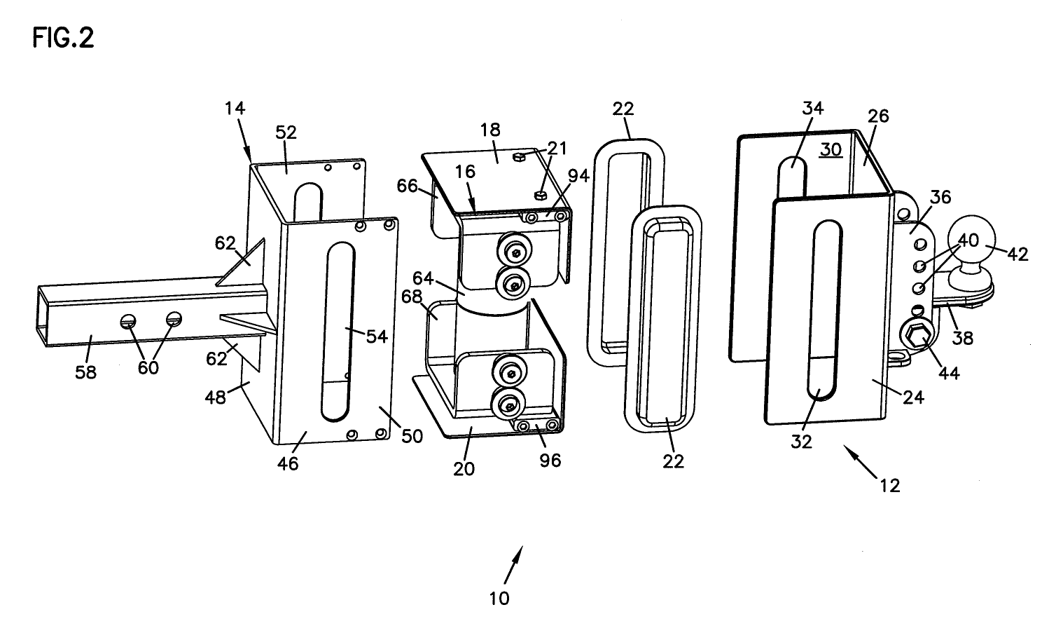

FIGS. 1A and 1B illustrate the hitch 10 in a fully assembled configuration. FIG. 2 illustrates the hitch 10 in an exploded configuration exposing the internal components of the hitch 10.

Referring to FIG. 2, the hitch 10 generally includes a front assembly 12, a rear assembly 14, an internal assembly 16, a top cover 18, a bottom cover 20, and a pair of side covers 22.

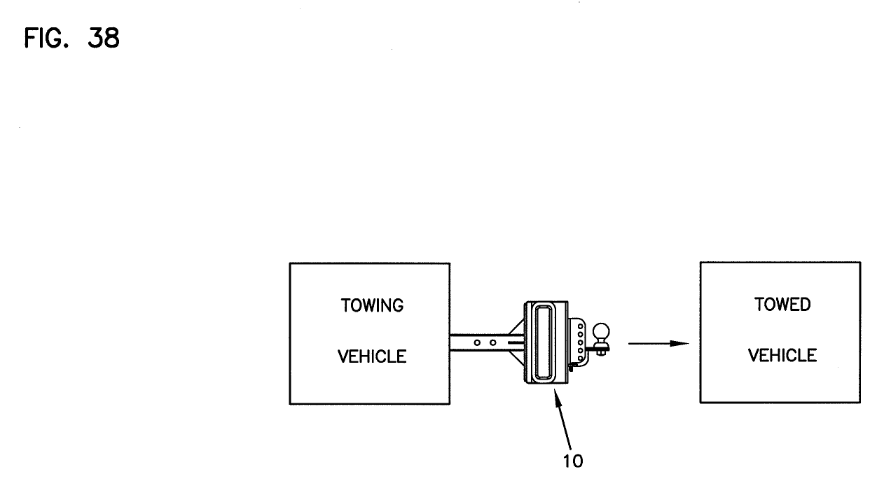

The front assembly 12 of the hitch 10 generally includes a front housing 24. The front housing 24 defines a front wall 26, a first sidewall 28 and a second sidewall 30. The first and second sidewalls 28, 30 of the front housing 24 include first and second longitudinal slots 32, 34, respectively. The front wall 26 of the front housing 24 includes a bracket 36 mounted thereon. The bracket 36 is configured for adjustably mounting a ball mount 38 of the front assembly 12. The bracket 36 includes a plurality of holes 40 for mounting the ball mount 38 at different height levels. The ball mount 38 includes a receiver ball 42 mounted thereon that is configured to be attached to a tongue of a towed vehicle or device. FIG. 38 shows a diagram illustrating the positioning of the hitch relative to a towing vehicle and a towed vehicle.

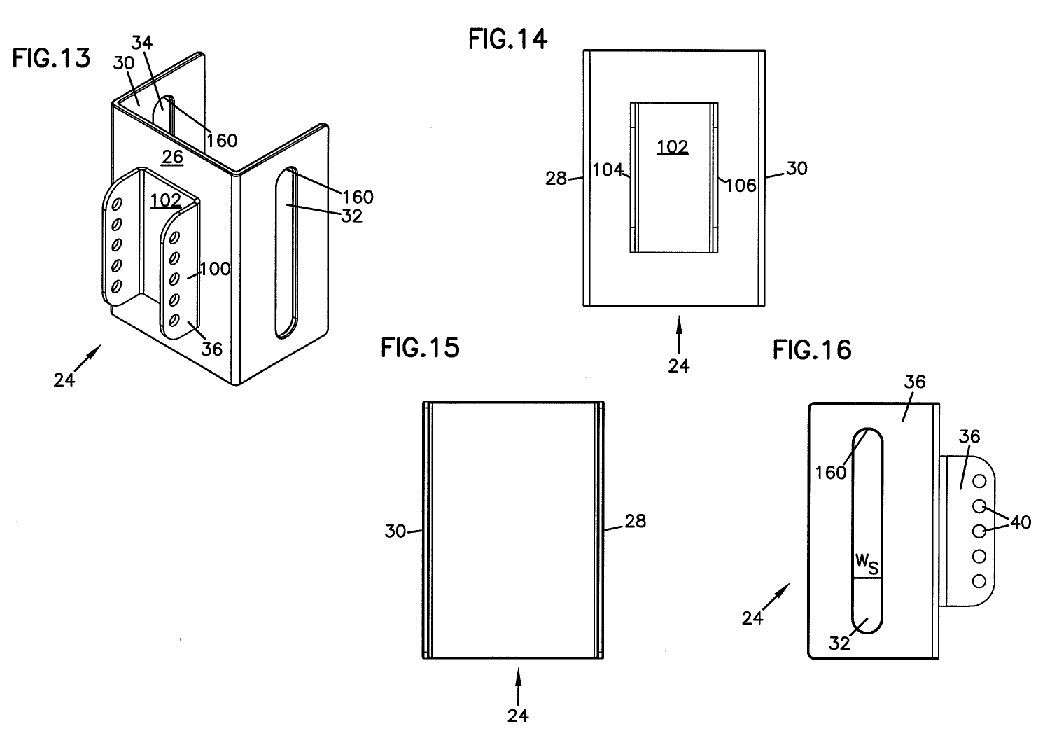

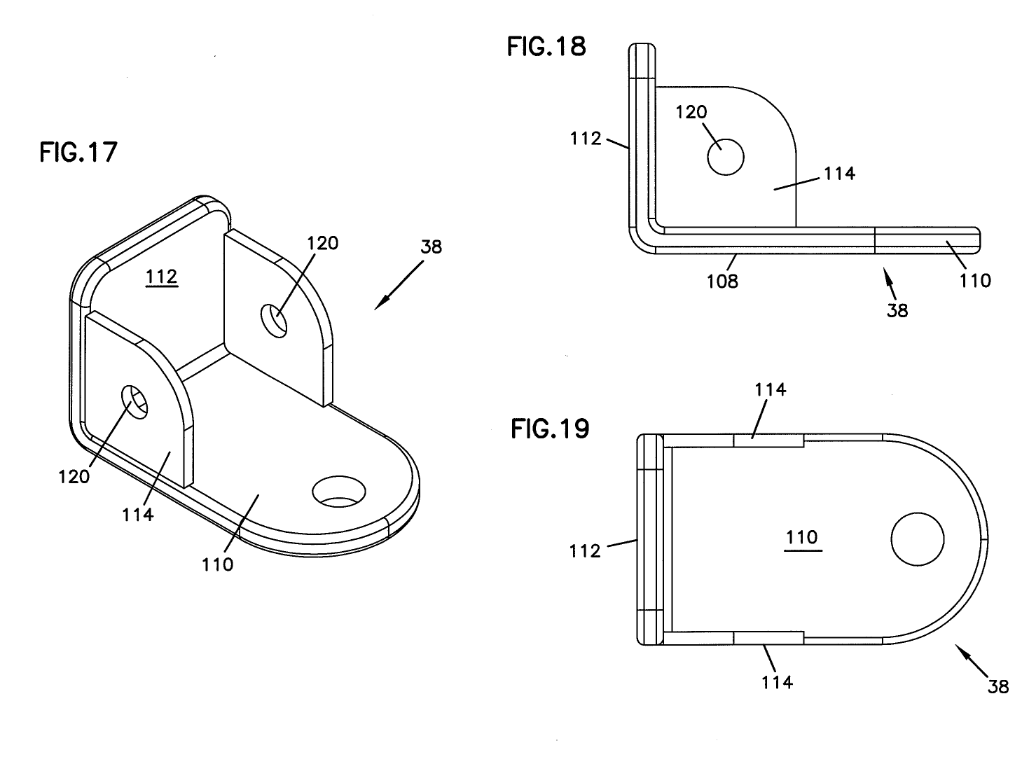

The front housing 24 of the front assembly 12 is illustrated in further detail in FIGS. 13-16. The ball mount 38 of the front assembly 12 including the receiver ball 42 and the bolt assembly 44 used to attach the ball mount 38 to the bracket 36 are illustrated in further detail in FIGS. 17-21.

Still referring to FIG. 2, the rear assembly 14 of the hitch 10 generally includes a rear housing 46 that defines a rear wall 48, a first sidewall 50 and a second sidewall 52. The first and second sidewalls 50, 52 include first and second longitudinal slots 54, 56, respectively. The rear wall 48 of the rear housing 46 includes a receiver tube 58 attached thereto. The receiver tube 58 is configured to be slid into a receiver mount of a towing vehicle, as known in the art. The receiver tube 58 includes a plurality of holes 60 for adjustably mounting the receiver tube 58 to the receiver mount of the towing vehicle. The receiver tube 58 is reinforced to the rear wall 48 of the rear housing 46 with a plurality of receiver tube gussets 62. FIG. 38 diagrammatically illustrates a towing vehicle that includes the hitch 10 of the present disclosure.

The hitch 10 of the present disclosure is configured to provide shock absorption protection both in the downward direction and the upward direction. As will be described in further detail below, the internal assembly 16 of the hitch 10 provides a cushion of air for the hitch 10 that allows for shock absorption protection in both the downward direction and the upward direction.

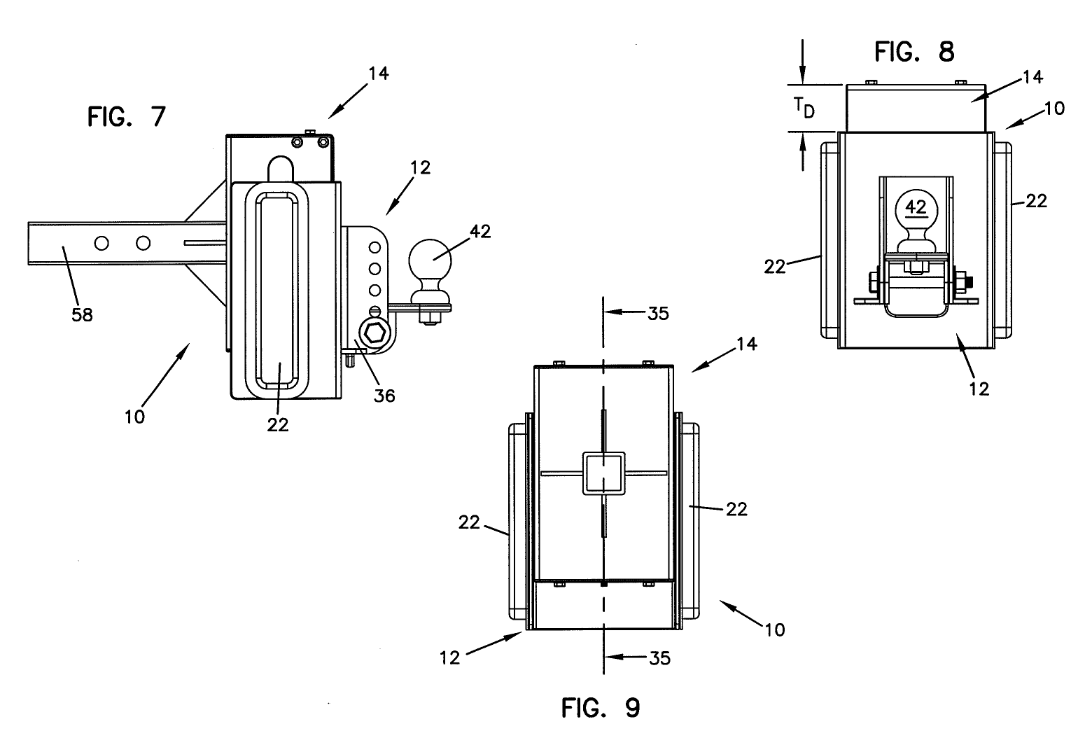

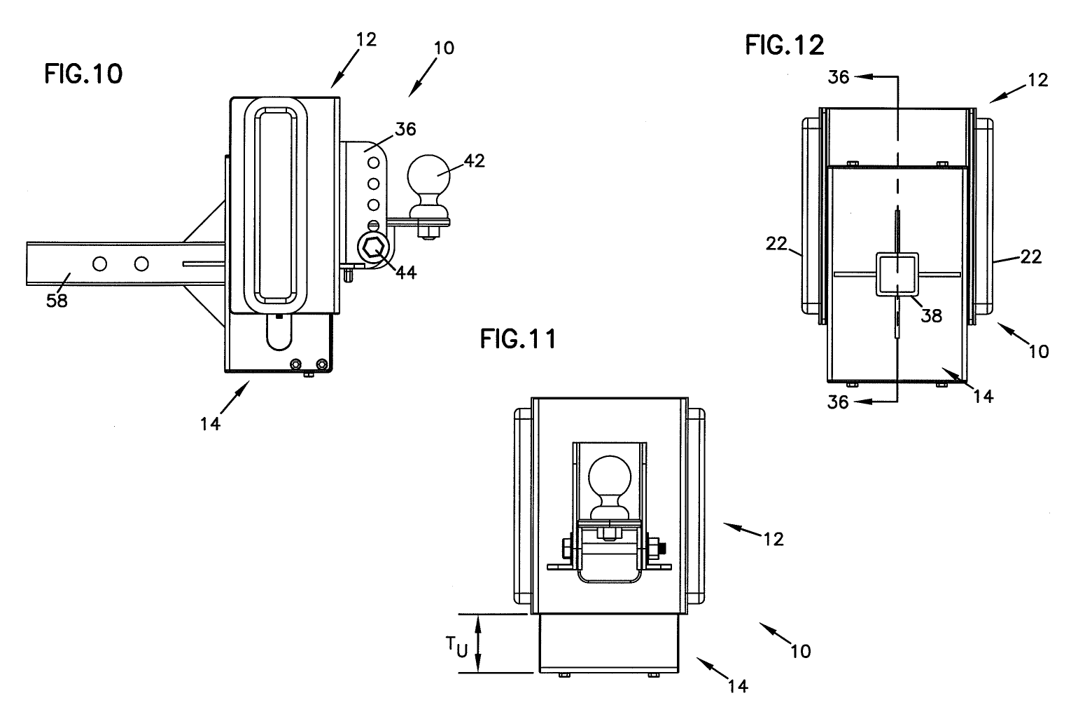

Still referring to FIG. 2, the front assembly 12 of the hitch 10 is configured to slidably move with respect to the rear assembly 14 to absorb forces both in a downward direction and an upward direction. As will be discussed in further detail below, both the front assembly 12 and the rear assembly 14 are coupled to the internal assembly 16. When the hitch 10 is fully assembled, the front assembly 12 overlaps the rear assembly 14, with the slots 32, 34 of the front housing 24 aligned over the slots 54, 56 of the rear housing 46. The downward movement of the front assembly 12 with respect to the rear assembly 14 to absorb downwardly directed shocks is illustrated in FIGS. 7-9. The upward movement of the front assembly 12 with respect to the rear assembly 14 to absorb upwardly directed shocks is illustrated in FIGS. 10-12.

Referring back to FIG. 2, the internal assembly 16 generally includes a shock absorber 64 (i.e., biasing member) mounted between an upper shock absorber mount 66 and a lower shock absorber mount 68. In the depicted embodiment, the shock absorber 64 includes an air container 70 that provides a biasing force via compressed air. Other types of shock absorbers, such as compression springs, dampers, etc., may also be used in accordance with the principles of the present disclosure.

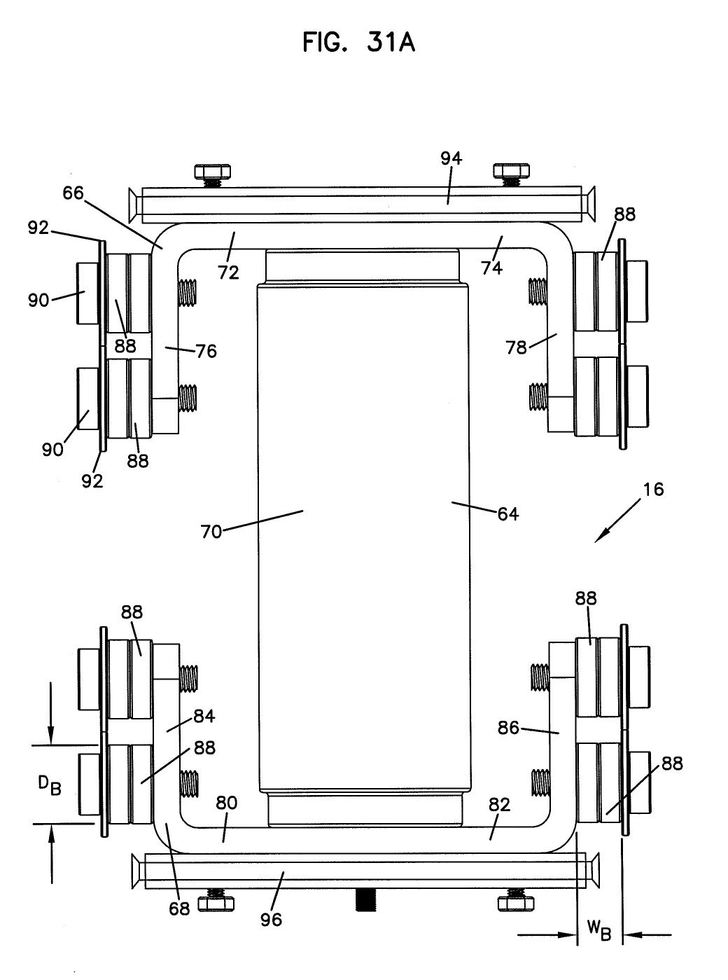

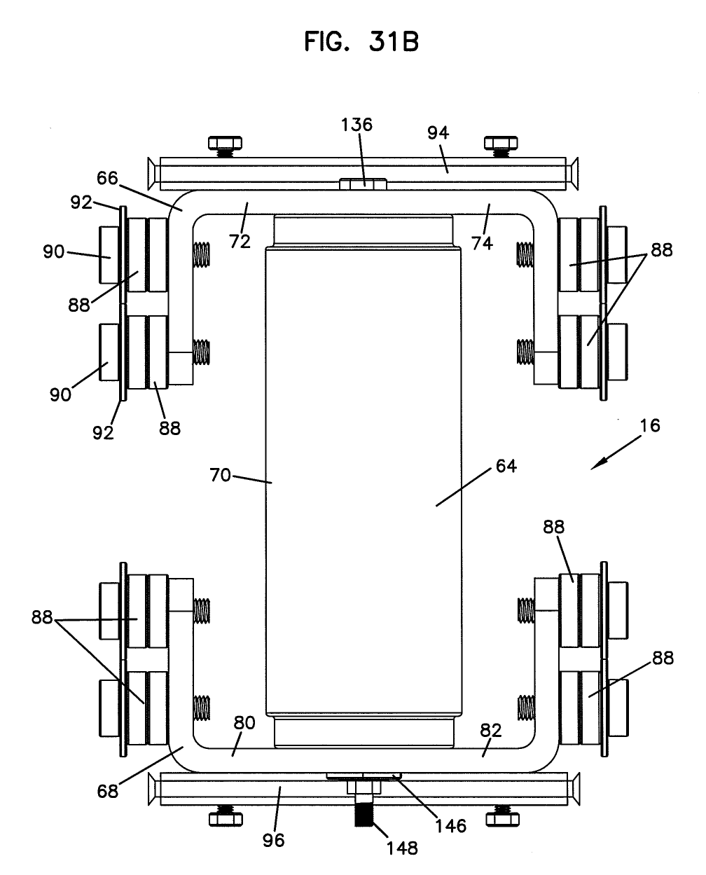

The upper shock absorber mount 66 includes a U-shaped body 72 with an upper wall 74 and downwardly extending first and second sidewalls 76, 78. Likewise, the lower shock absorber mount 68 also includes a U-shaped body 80 with a lower wall 82 and upwardly extending first and second sidewalls 84, 86. The upper shock absorber mount 66 includes a plurality of roller bearings 88 mounted on each of the first and second sidewalls 76, 78. Likewise, the lower shock absorber mount 68 includes a plurality of roller bearings 88 mounted on each of the first and second sidewalls 84, 86. The roller bearings 88 are mounted to the sidewalls of the upper and lower shock absorber mounts 66, 68 via shoulder bolts 90 and washers 92 (see FIGS. 31A and 31B).

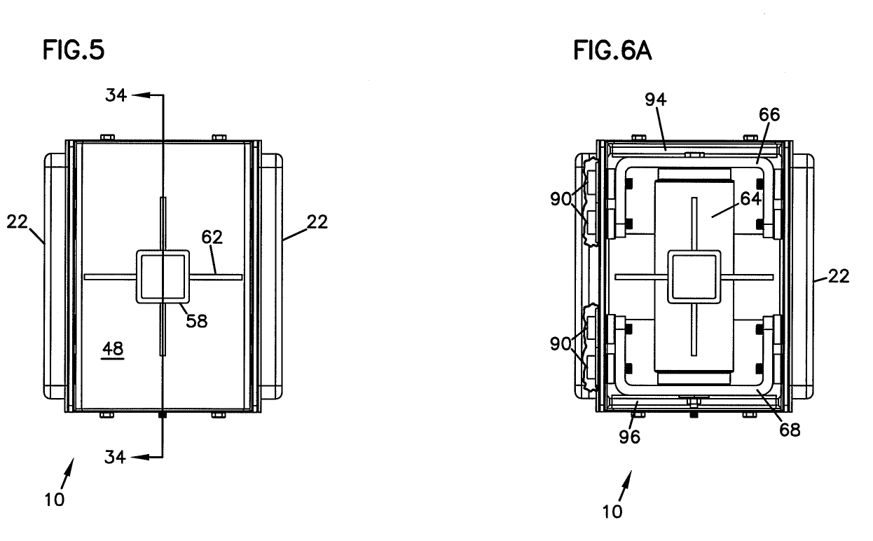

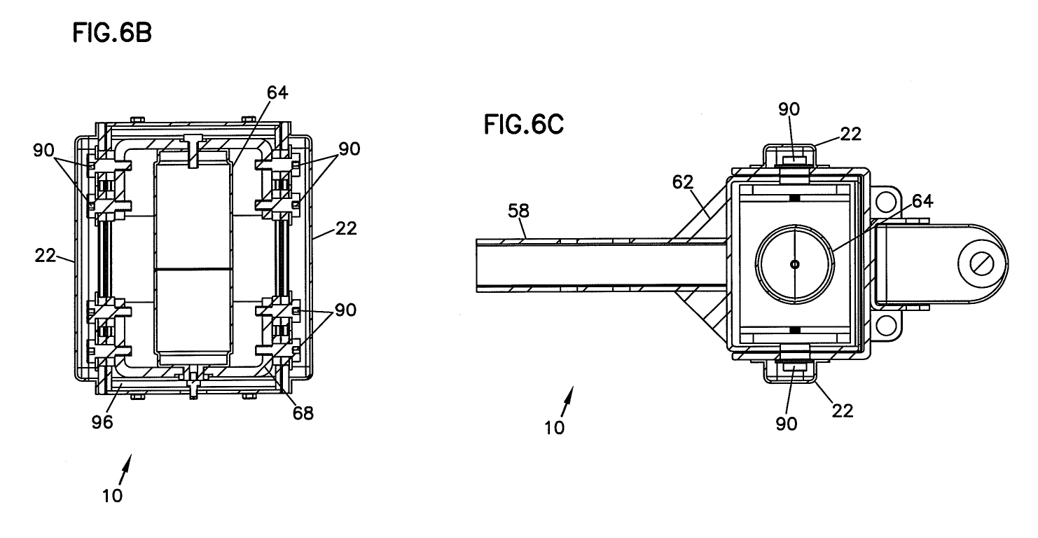

As discussed previously, when the hitch 10 is assembled, the slots 32, 34 of the front housing 24 and the slots 54, 56 of the rear housing 46 are in an overlapping configuration with the roller bearings 88 received within the slots. FIG. 4 illustrates a fully assembly view of the hitch 10 with a side cover 22 of the hitch 10 removed to expose the mounting arrangement of the front assembly 12 and the rear assembly 14 with respect to the roller bearings 88. FIG. 6A illustrates a rear view of the hitch 10 with the rear wall 48 of the rear housing 46 removed to expose the internal assembly 16 mounted within the hitch 10. FIGS. 6B and 6C are cross-sectional views showing the internal assembly 16 mounted within the hitch 10.

Referring back to FIG. 2, the hitch 10 includes a top cover 18 and a bottom cover 20. Both the top cover 18 and the bottom cover 20 of the hitch 10 are fastened to the rear housing 46 through an upper insert 94 and a lower insert 96, respectively. The upper insert 94 is attached to the top cover 18 via fasteners 21 and the lower insert 96 is attached to the bottom cover 20 via fasteners 23. The internal assembly 16 of the hitch 10 sits in a floating configuration between the top and bottom covers 18, 20. As will be discussed in further detail below, the upper and lower inserts 94, 96, not only are used to fasten the top and bottom covers 18, 20 to the rear housing 46, but also act as stops for the shock absorber mounts 66, 68 when the shock absorber 64 is compressed either upwardly or downwardly.

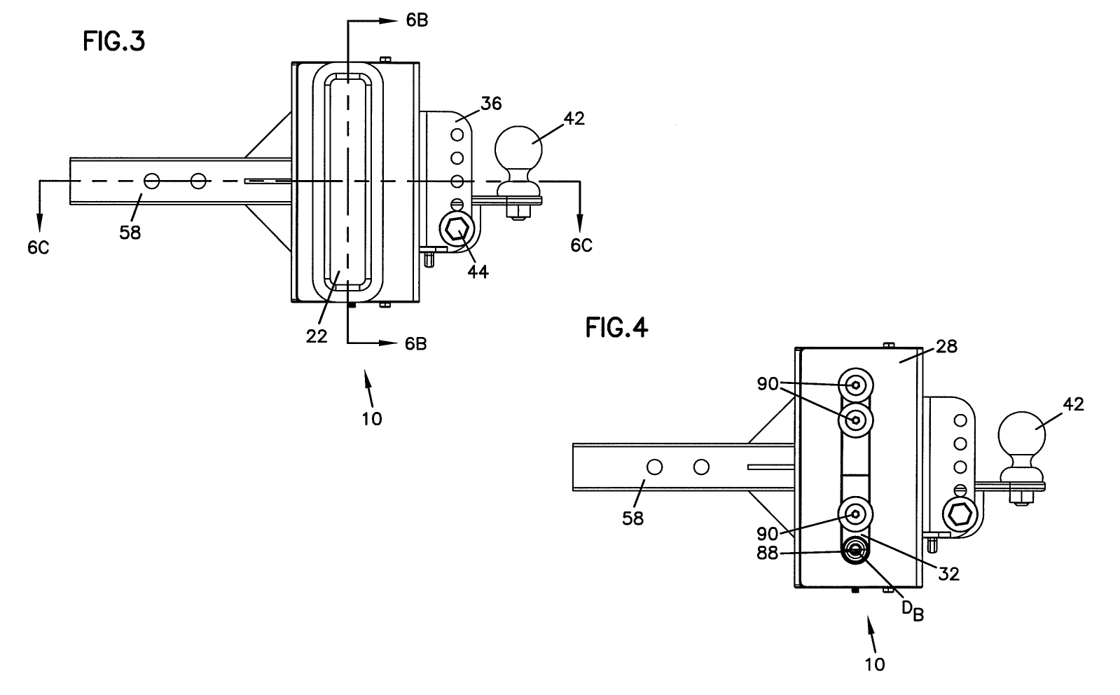

The hitch 10 also includes a pair of side covers 22 that are used to cover the roller bearings 88. FIGS. 1A, 1B, and 3 show the hitch 10 in a fully assembled configuration including the side covers 22 mounted thereon when the hitch 10 is in a neutral position.

Referring now to FIGS. 13-16, the front housing 24 of the hitch 10 is illustrated in greater detail. The bracket 36 for mounting the ball mount 38 to the front housing 24 includes a U-shaped body 100 with a rear plate 102 and a pair of side plates 104, 106. The rear plate 102 of the bracket 36 may be welded to the front wall 26 of the front housing 24. Other attachment means, such as fasteners, etc., are also possible.

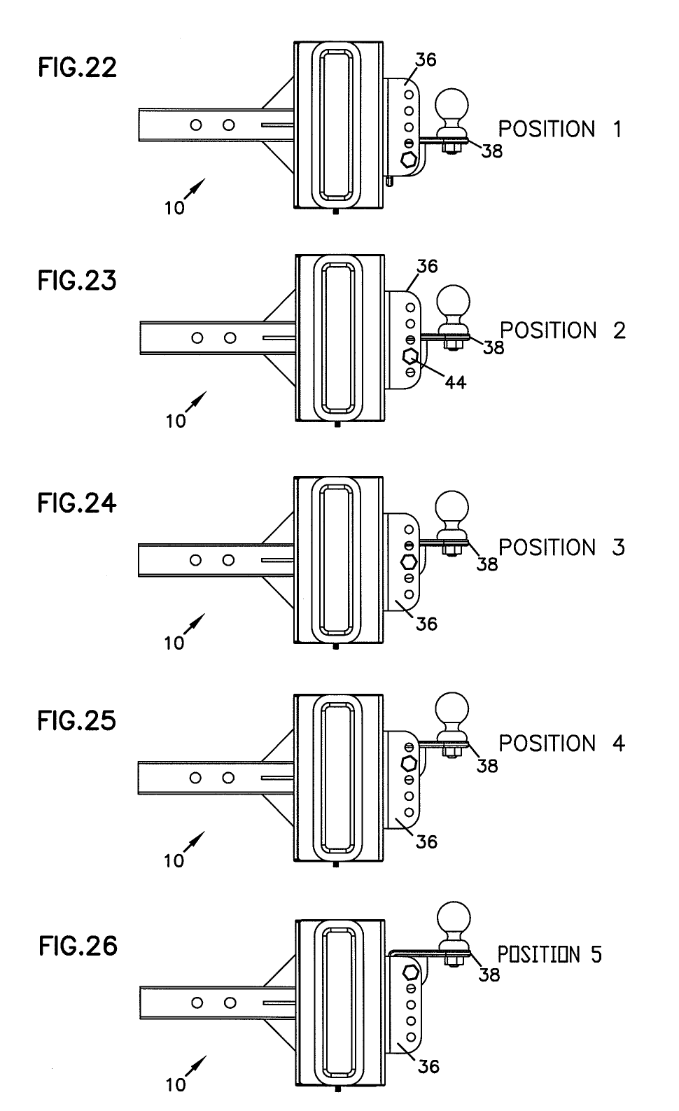

Each side plate 104, 106 of the bracket 36 includes five vertically arranged holes 40. The holes 40 allow for adjustable mounting of the ball mount 38 in five different vertical positions, depending upon the relative height differences of the tongue of the towed vehicle and the ball 42 of the towing vehicle. The five different positions are illustrated in FIGS. 22-26. It should be noted that other number of adjustment positions are also possible. In addition, in other embodiments, other means of varying the mounting height of the ball 42 with respect to the front housing 24 of the hitch 10 may be used.

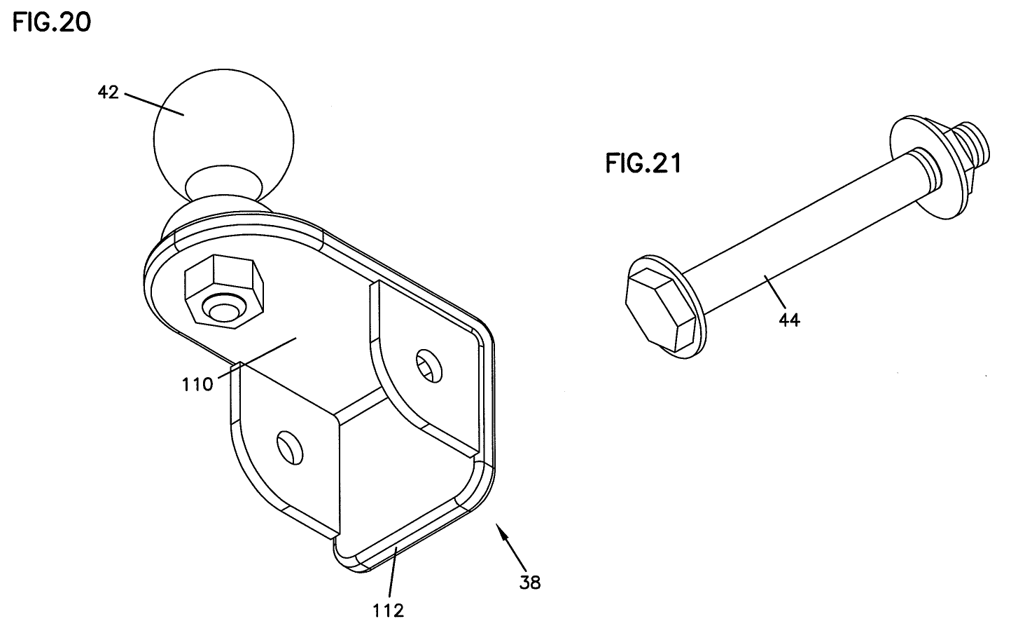

FIGS. 17-19 illustrate in greater detail the ball mount 38 of the hitch 10. The ball mount 38 generally has an L-shaped body 108 with an upper plate 110, a rear plate 112 and a pair of ball mount gussets 114 welded thereinbetween. The upper plate 110 includes an opening 116 for receiving the receiver ball 42 with a fastener 118 (see FIG. 20). The gussets 114 include holes 120 for receiving a bolt assembly 44 (see FIG. 21). The bolt assembly 44 is used to selectively mount the ball mount 42 to the bracket 36 of the front housing 24 at a plurality of different vertical positions along the bracket 36, as shown in FIGS. 22-26.

When the ball mount 38 is mounted on the bracket 36, the rear plate 112 of the ball mount 38 is configured to abut against the rear plate 102 of the bracket 36. In this manner, the ball mount 38 stays stationary with respect to the bracket 36 and does not pivot upwardly or downwardly when an upward or downward force is exerted on the hitch 10. Thus, all of the vertical forces are transferred to the shock absorber 64 through the movement of the front assembly 12 with respect to the rear assembly 14.

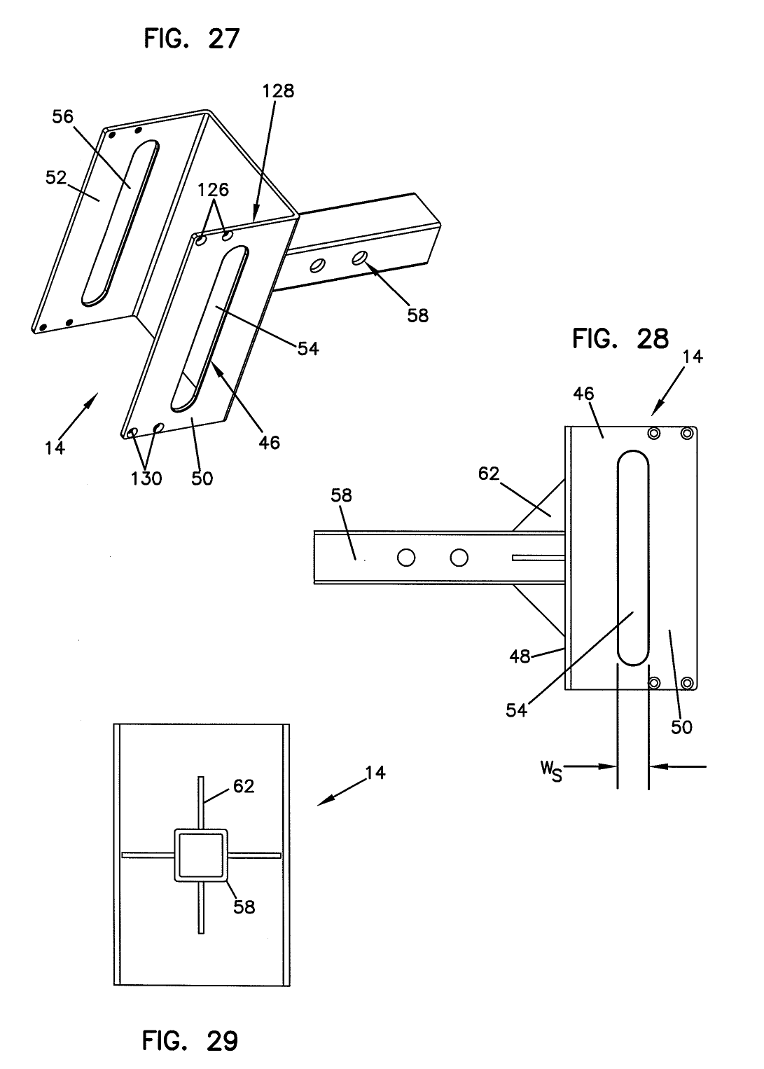

FIGS. 27-29 illustrate the rear assembly 14 of the hitch 10 in greater detail. The receiver tube gussets 62 may be welded to the rear wall 48 of the rear housing 46. Other fastening techniques may also be used. Each sidewall 50, 52 of the rear housing 46 includes a pair of fastener openings 126 adjacent the top side 128 and a pair of openings 130 adjacent the bottom side 132 for mounting the upper and lower inserts 94, 96, respectively (see FIG. 2). Through the inserts 94, 96, the top cover 18 and the bottom cover 20 of the hitch 10 are fastened to the rear housing 46. The rear housing 46 is sized such that, when the hitch 10 is fully assembled and the roller bearings 88 are received within the slots 32, 34, 54, 56, the sidewalls 28, 30 of the front housing 24 overlap the sidewalls 50, 52 of the rear housing 46.

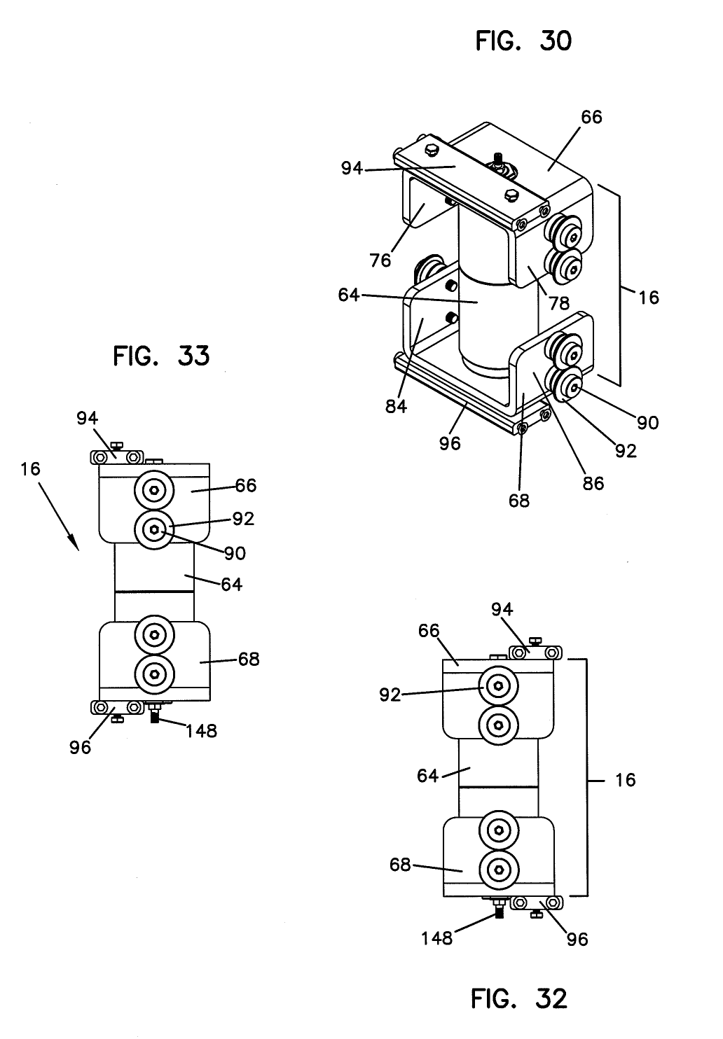

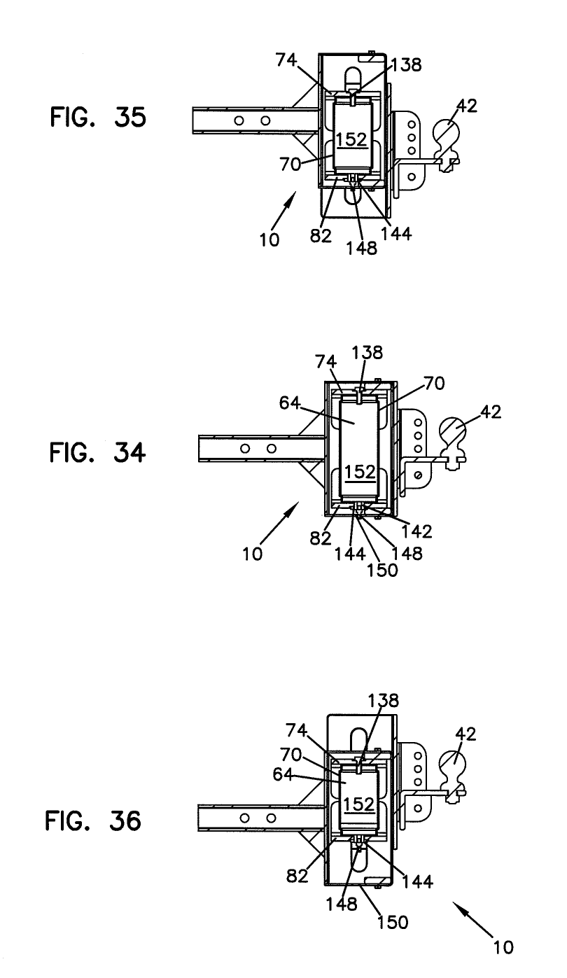

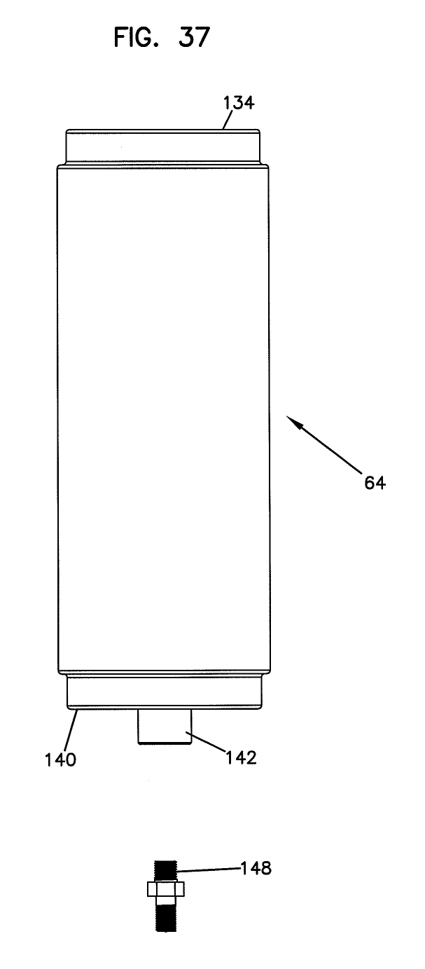

FIGS. 30-33 illustrate the internal assembly 16 of the hitch 10. As described previously, the internal assembly 10 includes a shock absorber 64 (i.e., biasing member) in the form of an air container 70 mounted to an upper mount 66 and a lower mount 68. In other embodiments, other types of shock absorbers may be used. The top end 134 of the shock absorber 64 is fastened to the upper wall 74 of the upper shock absorber mount 66 via a bolt 136 going through a hole 138 in the upper wall 74 (see FIGS. 34-36). The bottom end 140 of the shock absorber 64 includes a threaded stud 142 that goes through an opening 144 in the lower wall 82 of the lower shock absorber mount 68 (see FIGS. 30 and 34-36). A nut 146 is threaded over the threaded stud 142 to fasten the shock absorber 64 to the lower wall 82 of the lower shock absorber mount 68. An air valve 148 is fastened to the stud 142 of the shock absorber 64. The shock absorber 64 and the air valve 148 are illustrated in FIG. 37. The bottom cover 20 of the hitch 10 includes an opening 150 for accommodating and accessing the air valve 148, as shown in FIG. 1B and the cross-sectional views in FIGS. 34-36. In one embodiment, the shock absorber 64 comprises an air-filled polymeric bladder made and sold by Firestone Industrial Products Company under the trademark AIRIDE® Springs.

The air valve 148 is used to pump air into or draw air from an air chamber 152 of the shock absorber 64. The amount of air needed in the air chamber 152 is determined by the exerted weight on the tongue of the towed vehicle. Once the towed vehicle has been attached to the towing vehicle, air is pumped into the air chamber 152 until the front assembly 12 is horizontally aligned with the rear assembly 14. In one embodiment, the air container 70 has a maximum capacity of 100 psi. When an air container having a maximum capacity of 100 psi is used, the weight exerted by the tongue of the towed vehicle should not exceed the Class 3 TW classification. Configurations and operations of the shock absorber 64 and the air valve 148 depicted herein are well known in the art, and, therefore, further details thereof will not be provided herein, it being understood that those skilled in the art understand the nature of such devices and how they operate in numerous versatile situations.

As shown in the front and rear views of the internal assembly 16 of the hitch in FIGS. 31A and 31B, the roller bearings 88 are fastened to the sidewalls 76, 78 and 84, 86 of the upper and lower shock absorber mounts 66, 68 via shoulder bolts 90 and washers 92. As discussed previously, each of the front assembly 12 and the rear assembly 14 of the hitch 10 is configured to slidably move up or down with respect to the other, with the slots 32, 34 and 54, 56 of the front housing 24 and the rear housing 46 riding along the roller bearings 88. Referring to FIG. 31A, each roller bearing 88 defines a width W_{B} such that it accommodates both the sidewall of the front housing 24 and the sidewall of the rear housing 46 in an overlapping configuration.

In operation of the hitch 10, when a downward force is applied to the receiver ball 42, the top end 160 of the slots 32, 34 on both sides of the front housing 24 moves in a downward motion contacting the uppermost roller bearings 88 on each side of the hitch 10. The roller bearings 88, which are attached to the shock absorber 64, cause the shock absorber 64 to become compressed, cushioning the downward motion of the ball 42. A cross-sectional view of the hitch 10 is shown in FIG. 35 illustrating the shock absorber 64 in a compressed state due to a downward force. As force is reduced, the air in the air container 70 expands and returns ball 42 to the original starting position. The starting, neutral position is shown in FIG. 34.

When an upward force is applied to the ball 42, the bottom end 162 of the slots 32, 34 on both sides of the front housing 24 moves in an upward motion contacting the lowermost roller bearings 88 on each side of the hitch 10. The roller bearings 88, which are attached to the shock absorber 64, cause the shock absorber 64 to become compressed, cushioning the upward motion of the ball 42. A cross-sectional view of the hitch 10 is shown in FIG. 36 illustrating the shock absorber 64 in a compressed state due to an upward force. As force is reduced, the air in the air container 70 expands and returns ball 42 to the original starting position. The starting, neutral position is shown in FIG. 34.

The slots 32, 34, 54, 56 of the front and rear housings 24, 46 are preferably sized such that they generally include a width Ws similar to the diameter D_{B} of the roller bearings 88, leaving minimum amount of slack between the side edges of the slots and the roller bearings 88. In this manner, even if the force applied on the hitch 10 has a backward or a forward component, the hitch 10 only senses the upward or the downward component and movement of the ball 42 in the forward or the backward direction is prevented. All of the force, thus, is transferred to the upward or the downward direction.

It should be noted that, although the hitch described herein is configured to allow for shock absorption in the upward and downward directions, in other embodiments, the hitch can be configured to allow for shock absorption in other plurality of directions such as front to back.

Referring back to FIGS. 30-33, the upper and lower inserts 94, 96 are also shown in combination with the inner assembly 16. Since the inner assembly 16 is in a floating configuration within the hitch 10, the upper insert 94 acts as a stop when the inner assembly 16 is forced upwardly with the upper shock absorber mount 66 contacting the upper insert 94 (see FIG. 36). The lower insert 96 acts as a stop when the inner assembly 16 is forced downwardly with the lower shock absorber mount 68 contacting the lower insert 96 (see FIG. 35). FIG. 34 illustrates a cross-sectional view of the hitch 10 in a neutral position, exposing the internal assembly 16 within the hitch 10.

Referring now to FIGS. 8 and 11, in one embodiment, the hitch is configured to have a maximum downward travel distance T_{D} of 3 inches and a maximum upward travel distance T_{U} of 3 inches for a total travel distance of 6 inches. In another embodiment, the hitch is configured to have a maximum downward travel distance T_{D} of 3.5 inches and a maximum upward travel distance T_{U} of 3.5 inches for a total travel distance of 7 inches. Other shock absorbers allowing for different travel distances are possible.

When towing a device or another vehicle, since any shock or force from bumps or dips encountered by the towed vehicle is absorbed by the hitch 10, the transfer to the towing vehicle of a sudden shock in either the downward direction or the upward direction is minimized. This reduces wear and tear on both the towed vehicle and the towing vehicle. It will also limit any sudden movements of the towed vehicle from interfering with the stability of the steering of the towing vehicle.

The above specification, examples and data provide a complete description of the inventive aspects of the disclosure. Many embodiments of the disclosure can be made without departing from the spirit and scope of the inventive aspects of the disclosure.

1. A hitch for towing, the hitch comprising:
a first portion configured to be mounted on a towing vehicle; and
a second portion configured to be attached to a towed vehicle;
wherein at least one of the first portion and the second portion is configured to slidably move relative to the other of the first portion and the second portion vertically in both the upward direction and the downward direction.

2. A hitch according to claim 1, further comprising a biasing member configured to absorb shocks from the relative movement between the first portion and the second portion both in the upward direction and the downward direction.

3. A hitch according to claim 2, wherein the biasing member includes an air container.

4. A hitch according to claim 2, wherein a biasing force of the biasing member is adjustable.

5. A hitch according to claim 3, wherein the air container includes an air valve for varying the air pressure within the air container for varying a biasing force of the air container.

6. A hitch according to claim 1, wherein the first portion includes a receiver tube for slidably mounting into a receiver mount of the towing vehicle and the second portion includes a ball mount with a receiver ball.

7. A hitch according to claim 6, wherein the ball mount of the second portion is height adjustable relative to a main housing of the second portion to level the towed vehicle with respect to the towing vehicle.

8. A hitch according to claim 1, wherein at least one of the first portion and the second portion rides along roller bearings when slidably moving with respect to the other of the first portion and the second portion.

9. A hitch according to claim 1, wherein the first portion and the second portion have a total vertical relative travel capacity of about 6 inches, wherein the first portion is configured to move relative to the second portion a maximum distance of about 3 inches in the downward direction and a maximum distance of about 3 inches in the upward direction.

10. A hitch according to claim 1, wherein the first portion and the second portion have a total vertical relative travel capacity of about 7 inches, wherein the first portion is configured to move relative to the second portion a maximum distance of about 3.5 inches in the downward direction and a maximum distance of about 3.5 inches in the upward direction.

11. A vehicle comprising:
a hitch including a first portion mounted on the vehicle and a second portion configured to be attached to a second vehicle to be towed by the vehicle;
wherein at least one of the first portion and the second portion is configured to slidably move relative to the other of the first portion and the second portion vertically in both the upward direction and the downward direction to accommodate any relative movement in the vertical direction between the vehicle and the second vehicle.

12. A vehicle according to claim 11, wherein the hitch includes a biasing member configured to absorb shocks from the relative movement between the first portion and the second portion in both the upward direction and the downward direction.

13. A vehicle according to claim 12, wherein the biasing member includes an air container.

14. A vehicle according to claim 12, wherein a biasing force of the biasing member is adjustable.

15. A vehicle according to claim 11, wherein the first portion of the hitch includes a receiver tube slidably mounted within a receiver mount of the vehicle and the second portion of the hitch includes a ball mount with a receiver ball.

16. A vehicle according to claim 11, wherein at least one of the first portion and the second portion of the hitch rides along roller bearings when slidably moving with respect to the other of the first portion and the second portion.

17. A vehicle according to claim 11, wherein the first portion and the second portion of the hitch have a total vertical relative travel capacity of about 6 inches, wherein the first portion is configured to move relative to the second portion a maximum distance of about 3 inches in the downward direction and a maximum distance of about 3 inches in the upward direction.

18. A vehicle according to claim 11, wherein the first portion and the second portion of the hitch have a total vertical relative travel capacity of about 7 inches, wherein the first portion is configured to move relative to the second portion a maximum distance of about 3.5 inches in the downward direction and a maximum distance of about 3.5 inches in the upward direction.

19. A hitch for towing, the hitch comprising:
a front member including a ball mount configured to be attached to a towed vehicle;
a rear member including a receiver tube configured to be slidably mounted into a receiver mount of a towing vehicle, wherein at least one of the front member and the rear member is configured to slidably move relative to the other of the front member and the rear member vertically in both the upward direction and the downward direction; and
an intermediate member including a biasing member configured to absorb shocks from the relative movement between the front member and the rear member in both the upward direction and the downward direction;
wherein at least one of the front member and the rear member rides along roller bearings provided on the intermediate member when slidably moving with respect to the other of the front member and the rear member.

20. A method of towing a vehicle, the method comprising:
providing a hitch including a first portion and a second portion, at least one of the first portion and the second portion being configured to slidably move relative to the other of the first portion and the second portion vertically in both the upward direction and the downward direction;
mounting the first portion on a towing vehicle; and
attaching the second portion to a towed vehicle.
